(19) United States
(12) Patent Application Publication
(10) Pub. No.: US 2026/0296781 A1
(43) Pub. Date: Oct. 1, 2026

(54) ACCESS STATION WITH STOPPER MECHANISM

(71) Applicant: AUTOSTORE TECHNOLOGY AS, Nedre Vats (NO)

(72) Inventor: Abel Bajay, NedrE Vats (NO)

(73) Assignee: AUTOSTORE TECHNOLOGY AS, Nedre Vats (NO)

(21) Appl. No.: 19/479,110

(22) PCT Filed: Apr. 26, 2024
(86) PCT No.: PCT/EP2024/061690

§ 371 Date: Oct. 27, 2025

(30) Foreign Application Priority Data
Apr. 28, 2023 (NO) 20230482

(51) Int. Cl. B65G 1/04

(52) U.S. Cl. CPC B65G 1/0464; B65G 2207/40

(57) ABSTRACT

An access station for an automated storage and retrieval system having a storage section for storing storage containers comprises a frame structure enclosing a receiving space for receiving a storage container to be transferred from or into the storage section along a conveying path, an access opening for accessing the receiving space from externally of the access station, a movable cover element for selectively covering the access opening, and a stopper mechanism wherein the cover element is configured to move along a cover path between an open position and a closed position, wherein the stopper mechanism comprises at least one blocking element, which is toggleable between a blocking position and a release position, wherein the blocking element is in the blocking position when the cover element is in the open position, and in a release position when the cover element is in the closed position, and wherein when in the blocking position, the blocking element blocks the conveying path for storage containers.

### FIELD

The present disclosure relates to an automated storage and retrieval system for storage and retrieval of containers, in particular to an access station for an automated storage and retrieval system, to an automated storage and retrieval system, as well as to a method for operating an access station for an automated storage and retrieval system.

### BACKGROUND

FIG. 1 discloses a prior art automated storage and retrieval system 1 with a framework structure 100 and FIGS. 2, 3 and 4 disclose three different prior art container handling vehicles 201,301,401 suitable for operating on such a system 1. The framework structure 100 comprises upright members 102 and a storage volume comprising storage columns 105 arranged in rows between the upright members 102. In these storage columns 105 storage containers 106, also known as bins, are stacked one on top of one another to form stacks 107. The members 102 may typically be made of metal, e.g. extruded aluminum profiles.

The framework structure 100 of the automated storage and retrieval system 1 comprises a rail system 108 arranged across the top of framework structure 100, on which rail system 108 a plurality of container handling vehicles 201,301,401 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 201,301,401 in a first direction X across the top of the framework structure 100, and a second set of parallel rails 111 arranged perpendicular to the first set of rails 110 to guide movement of the container handling vehicles 201,301,401 in a second direction Y which is perpendicular to the first direction X. Containers 106 stored in the columns 105 are accessed by the container handling vehicles 201,301,401 through access openings 112 in the rail system 108. The container handling vehicles 201,301,401 can move laterally above the storage columns 105, i.e. in a plane which is parallel to the horizontal X-Y plane.

The upright members 102 of the framework structure 100 may be used to guide the storage containers during raising of the containers out from and lowering of the containers into the columns 105. The stacks 107 of containers 106 are typically self-supporting.

Each prior art container handling vehicle 201,301,401 comprises a vehicle body 201a,301a,401a and first and second sets of wheels 201b, 201c, 301b, 301c,401b,401c which enable the lateral movement of the container handling vehicles 201,301,401 in the X direction and in the Y direction, respectively. In FIGS. 2, 3 and 4 two wheels in each set are fully visible. The first set of wheels 201b,301b,401b is arranged to engage with two adjacent rails of the first set 110 of rails, and the second set of wheels 201c,301c,401c is arranged to engage with two adjacent rails of the second set 111 of rails. At least one of the sets of wheels 201b, 201c, 301b,301c,401b,401c can be lifted and lowered, so that the first set of wheels 201b,301b,401b and/or the second set of wheels 201c,301c,401c can be engaged with the respective set of rails 110, 111 at any one time.

Each prior art container handling vehicle 201,301,401 also comprises a lifting device for vertical transportation of storage containers 106, e.g. raising a storage container 106 from, and lowering a storage container 106 into, a storage column 105. The lifting device comprises one or more gripping/engaging devices which are adapted to engage a storage container 106, and which gripping/engaging devices can be lowered from the vehicle 201,301,401 so that the position of the gripping/engaging devices with respect to the vehicle 201,301,401 can be adjusted in a third direction Z which is orthogonal the first direction X and the second direction Y. Parts of the gripping device of the container handling vehicles 301,401 are shown in FIGS. 3 and 4 indicated with reference number 304,404. The gripping device of the container handling device 201 is located within the vehicle body 201a in FIG. 2 and is thus not shown.

Conventionally, and also for the purpose of this application, Z=1 identifies the uppermost layer available for storage containers below the rails 110,111, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=17, Y=1, Z=6. The container handling vehicles 201,301,401 can be said to travel in layer Z=0, and each storage column 105 can be identified by its X and Y coordinates. Thus, the storage containers shown in FIG. 1 extending above the rail system 108 are also said to be arranged in layer Z=0.

The storage volume of the framework structure 100 has often been referred to as a grid 104, where the possible storage positions within this grid are referred to as storage cells. Each storage column may be identified by a position in an X- and Y-direction, while each storage cell may be identified by a container number in the X-, Y- and Z-direction.

Each prior art container handling vehicle 201,301,401 comprises a storage compartment or space for receiving and stowing a storage container 106 when transporting the storage container 106 across the rail system 108. The storage space may comprise a cavity arranged internally within the vehicle body 201a,401a as shown in FIGS. 2 and 4 and as described in e.g. WO2015/193278A1 and WO2019/206487A1, the contents of which are incorporated herein by reference.

FIG. 3 shows an alternative configuration of a container handling vehicle 301 with a cantilever construction. Such a vehicle is described in detail in e.g. NO317366, the contents of which are also incorporated herein by reference.

The cavity container handling vehicle 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’ used herein may mean ‘horizontal’.

Alternatively, the cavity container handling vehicles 401 may have a footprint which is larger than the lateral area defined by a storage column 105 as shown in FIGS. 1 and 4, e.g. as is disclosed in WO2014/090684A1 or WO2019/206487A1.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail 110,111 may comprise two parallel tracks. In other rail systems 108, each rail in one direction (e.g. an X direction) may comprise one track and each rail in the other, perpendicular direction (e.g. a Y direction) may comprise two tracks. Each rail 110,111 may also comprise two track members that are fastened together, each track member providing one of a pair of tracks provided by each rail.

WO2018/146304A1, the contents of which are incorporated herein by reference, illustrates a typical configuration of rail system 108 comprising rails and parallel tracks in both X and Y directions.

In the framework structure 100, a majority of the columns are storage columns 105, i.e. columns 105 where storage containers 106 are stored in stacks 107. In addition to storage columns 105, there are special-purpose columns within the framework structure. In FIG. 1, columns 119 and 120 are such special-purpose columns used by the container handling vehicles 201,301,401 to drop off and/or pick up storage containers 106 so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119,120. The transportation to the access station may be in any direction, that is horizontal, tilted and/or vertical. For example, the storage containers 106 may be placed in a random or dedicated column 105 within the framework structure 100, then picked up by any container handling vehicle and transported to a port column 119,120 for further transportation to an access station. The transportation from the port to the access station may require movement along various different directions, by means such as delivery vehicles, trolleys or other transportation lines. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 201,301,401 can drop off storage containers 106 to be transported to an access or a transfer station, and the second port column 120 may be a dedicated pick-up port column where the container handling vehicles 201,301,401 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1, but are returned into the framework structure 100 again once accessed. A port can also be used for transferring storage containers to another storage facility (e.g. to another framework structure or to another automated storage and retrieval system), to a transport vehicle (e.g. a train or a lorry), or to a production facility.

A conveyor system comprising conveyors is normally employed to transport the storage containers between the port columns 119,120 and the access station.

If the port columns 119,120 and the access station are located at different levels, the conveyor system may comprise a lift device with a vertical component for transporting the storage containers 106 vertically between the port column 119,120 and the access station.

The conveyor system may be arranged to transfer storage containers 106 between different framework structures, e.g. as is described in WO2014/075937A1, the contents of which are incorporated herein by reference.

When a storage container 106 stored in one of the columns 105 disclosed in FIG. 1 is to be accessed, one of the container handling vehicles 201,301,401 is instructed to retrieve the target storage container 106 from its position and transport it to the drop-off port column 119. This operation involves moving the container handling vehicle 201,301,401 to a location above the storage column 105 in which the target storage container 106 is positioned, retrieving the storage container 106 from the storage column 105 using the container handling vehicle's 201,301,401 lifting device (not shown), and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles 201,301,401 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201,301,401 is instructed to pick up the storage container 106 from the pick-up port column 120 and transport it to a location above the storage column 105 where it is to be stored. After any storage containers 106 positioned at or above the target position within the stack 107 have been removed, the container handling vehicle 201,301,401 positions the storage container 106 at the desired position. The removed storage containers 106 may then be lowered back into the storage column 105, or relocated to other storage columns 105.

For monitoring and controlling the automated storage and retrieval system 1, e.g. monitoring and controlling the location of respective storage containers 106 within the framework structure 100, the content of each storage container 106, and the movement of the container handling vehicles 201,301,401 so that a desired storage container 106 can be delivered to the desired location at the desired time without the container handling vehicles 201,301,401 colliding with each other, the automated storage and retrieval system 1 comprises a control system 500 which typically is computerized and which typically comprises a database for keeping track of the storage containers 106.

WO 2020/074717 A1 discloses an access station for picking storage containers. WO 2022/136423 A1 shows an automated storage and retrieval system having an access station.

An object of the present disclosure lies in providing an access station for an automated storage and retrieval system that is capable of presenting storage containers and that is capable of preventing a user from moving storage containers intentionally or unintentionally away from the access station.

### SUMMARY

This summary is provided to introduce in simplified form a selection of concepts that are further described herein. The summary is not intended to identify key or essential features of the invention.

The presently claimed invention is set forth and characterized in the independent claims, while the dependent claims describe other characteristics of the presently claimed invention.

In one aspect, there is provided an access station for an automated storage and retrieval system having a storage section for storing storage containers, the access station comprising a frame structure enclosing a receiving space for receiving a storage container to be transferred from or into the storage section along a conveying path, an access opening for accessing the receiving space from externally of the access station, a movable cover element for selectively covering the access opening, and a stopper mechanism, wherein the cover element is configured to move along a cover path between an open position, e.g., in which the access opening is at least partially opened in order to allow access, and a closed position, e.g., in which the access opening is covered, wherein the stopper mechanism comprises at least one blocking element, which is toggleable between a blocking position and a release position, such that the blocking element is in the blocking position when the cover element (502) is in the open position, and in a release position when the cover element (502) is in the closed position. When in the blocking position, the blocking element blocks the conveying path for storage containers. The at least one blocking element may be arranged at an edge region of the access opening and may comprise a blocking section and a toggle section, wherein the at least one blocking element is configured to urge the toggle section into the cover path and the blocking section into the conveying path to block the conveying path for storage containers, and wherein the cover element is configured to slide over the toggle section of the at least one blocking element, such that it is urged out of the cover path to retract the blocking section from the conveying path, when the cover element is moved into the closed position.

The frame structure may be an assembly of components that form a part of the access station. Inside the frame structure, the receiving space is provided. Preferably, the receiving space is enclosed by the frame structure such that it is accessible from outside the frame structure only through the access opening.

The receiving space may be arranged at one end of the conveying path, along which storage containers are conveyed. The receiving space is capable of receiving storage containers delivered from the storage section of the automated storage and retrieval system. The dimensions of the receiving space are chosen to allow receiving any one of the storage containers stored in the storage section. A conveying device may reach into or extend to the receiving space, such that a storage container, which is conveyed by the conveying device, is movable into and removable from the receiving space.

The access opening allows a user to gain access to the storage container that is placed in the receiving space, when the cover element is in its open position. A user may then pick items from the respective storage container or place items into the storage container by moving them through the access opening. After the desired actions at the respective storage container are accomplished, the storage container may be conveyed back into the storage section of the automated storage and retrieval system along the conveying path.

The access opening may have a front edge and a rear edge. The front edge is arranged adjacent to a user position, where a user is present to interact with the access station. The rear edge is placed further to the storage section and may be opposed to the front edge. It is advantageous to place the at least one blocking element near the rear edge of the access opening.

The access opening may comprise an access opening contour, which defines an access opening plane that may be substantially horizontal. However, it may also define a slope from the rear edge to the front edge having a slope angle of up to about 30° to a horizontal plane.

The movable cover element may be a flexible, rollable element that is capable of closing the access opening like a blind. However, the cover element may also comprise a plurality of rigid elements that are connected to each other to form a roller-shutter-like device. Still further, the cover element may also be a substantially rigid element that is moved substantially parallel to its planar extension, e.g. in a sliding manner. The cover element is provided for selectively providing or blocking the access to the respective storage container in the receiving space.

The access station comprises a stopper mechanism that is capable of blocking the respective storage container in the receiving space, when the cover element is in the open position. The stopper mechanism thus prevents a manual push-back of the storage container into the storage section. The stopper mechanism is coupled with the cover element in a way that the state of the stopper mechanism directly depends on the position of the cover element. Thus, when the cover element is in the closed position or about to reach the closed position, the stopper mechanism is put into a release state, in which it releases the respective storage container. On the other hand, when the cover element is in the open position or about to reach the open position, the stopper mechanism is put into a blocking state, in which it blocks the respective storage container. Hence, a user may access the respective storage container as usual, but is not capable of pushing the storage container into the storage section when it is blocked by the stopper mechanism.

Preferably, the stopper mechanism is a passive device and does not require active components. A core element of the stopper mechanism is the at least one blocking element, which is capable of reaching into the conveying path to block the respective storage container. An example of the present disclosure includes coupling the at least one blocking element and the cover element by letting a toggle section of the at least one blocking element urge into the cover path, along which the cover element travels. The at least one blocking element may be configured to let the blocking section reach into the conveying path when the toggle section is placed in the cover path. When the cover travels along the cover path to the closed position, it slides over the toggle section, such that the toggle section is moved out of the cover path, leading to retracting the blocking section from the conveying path. When the cover opens again, it travels along the cover path in the opposite direction and releases the toggle section, such that the blocking section reverts into the conveying path. Hence, the state of the stopper mechanism is directly coupled with the position of the cover element. Depending on the embodiment of the at least one blocking element, it may rotate, swivel, translate or tilt between its two states.

The at least one blocking element may comprise a rocker arm with a first end and a second end, wherein the toggle section is arranged at the first end, wherein the blocking section is arranged at the second end, and wherein a rocker arm axle is arranged between the toggle section and the blocking section to swivably support the rocker arm.

The rocker arm may be a rigid component that is capable of swiveling about the rocker arm axle. When swiveling, the first end and the second end move in opposite directions. The rocker arm axle is preferably placed in a distance to the cover path and further to the receiving space, such that the rocker arm may freely swivel with the first end being able to reach into the cover path. It is advantageous if the rocker arm axle is aligned substantially perpendicular to the respective access opening edge and substantially parallel to the access opening. The shape and size of the rocker arm is selected in a way that the second end reaches into the conveying path when the first end is placed in the cover path. When the cover moves into the closed position, it slides over the toggle section at the first end and pushes the first end out of the cover path. In doing so, the rocker arm swivels around the rocker arm axle, and thereby moves the second end out of the conveying path.

The rocker arm axle may be arranged in a distance to the cover path and may be aligned substantially parallel to the access opening and substantially perpendicular to a movement direction of the cover element along the cover path. Consequently, the first end of the rocker arm directly follows the motion of the cover element and does not slant in the process. The motion of the cover element may thus preferably be directly tangential to the motion of the first end. For letting the rocker arm freely swivel about the rocker arm axle, the rocker arm axle is arranged between the access opening and the receiving space.

The stopper mechanism may comprise a peripheral element attached to a lateral side of the cover element and laterally protruding from the cover element, wherein the peripheral element may be designed to contact and slide over the at least one blocking element. The peripheral element is thus responsible for actuating the at least one blocking element. It is conceivable that the cover element is made from a material that is primarily chosen to serve the covering function. For example, it may be made from a comparably soft, or flexible plastic material. A continuous travel along the at least one blocking element may then lead to a local abrasion or wear. By placing a separate peripheral element on a lateral side of the cover element, this may be avoided. A sufficiently rigid material may be chosen for the peripheral element that is better suitable for actuating the at least one blocking element. Also, the at least one blocking element may be placed further away from the access opening contour, since the peripheral element extends away from the cover element. This may improve the placement of the at least one blocking element in the conveying path. The placement of the at least one blocking element can be further optimized, and the peripheral element may be attached to the cover element in a corresponding position. The placement of the at least one blocking element is thus independent from the design and delimiting edges of the cover element. It may thus be possible to select an opening degree, at which the respective storage container shall be blocked, by placing the at least one blocking element at a suitable position relative to the conveying path. An appropriate position of the peripheral component on the cover element may then be selected.

The cover element may be slidably supported in a pair of parallel guiding rails arranged along two opposite edges of the access opening, wherein the stopper mechanism may be arranged adjacent to or connected with one of the guiding rails. The guiding rails may be arranged underneath the access opening, such that the cover element travels underneath the access opening in order to open or close the access opening. However, the guiding rails may also be arranged above the access opening, such that the cover element travels above the access opening. In both cases, it is conceivable that the cover element overlaps the opposite edges of the access opening, preferably the front edge and the rear edge, as mentioned further above. The guiding rails may be provided in the form of elongated components with a selected profile. For example, they may have an elongated recess each, wherein each recess receives a lateral edge of the cover element. The lateral edges run inside one of the respective recesses. As another example, the rails may be provided in form of a rod that extends along the two opposite edges of the access opening, wherein a sliding element having a corresponding opening is arranged on each of the rods and connected to the cover element. By providing the guiding rails, the cover path is precisely defined.

The at least one blocking element may be arranged at a lateral side of a first one of the guiding rails, which faces away from a respective second one of the guiding rails. Thus, the at least one blocking element is placed lateral to the cover element and is attached to the first guiding rail. The respective blocking element thus does not interfere with the access opening.

The first guiding rail may comprise an elongated slot, through which the peripheral element may extend. The peripheral element reaches through the elongated slot in order to slide over the toggle section of the at least one blocking element, which is arranged laterally to the cover element and thus at a lateral side of the first guiding rail. Since the cover element is guided by the guiding rails, the peripheral element needs to stick through the elongated slot with a sufficient dimensional extension to reach over the at least one blocking element.

However, the first guiding rail does not necessarily require an elongated slot and the peripheral element may reach or extend around the first guiding rail. For this, it may have a cross-sectional profile that has at least one curvature, kink, bend or any other change of shape.

The peripheral element may be a flat component that substantially extends parallel to the cover element. The peripheral element may thus simply extend from a desired location on the cover element in a lateral direction. The dimensional extension depends on the location and number of blocking elements used in the stopper mechanism. The peripheral element may be made from a metallic material, which preferably comprises a sufficiently high wear resistance for a repeated contact with the at least one blocking element.

If, however, the first guiding rail does not have an elongated slot, the peripheral element may have a shape that is not flat, as explained further above.

The rocker arm may be arranged in a recess of a rocker arm housing, which is designed to limit a swivel range of the rocker arm. The rocker arm housing is designed according to the shape and size of the rocker arm. The rocker arm housing may be made from a plastic or metallic material. For example, it may be produced in a die casting process. The outer delimiting surfaces of the rocker arm housing is preferably adapted to a contact surface of the respective guiding rail or other part, to which the rocker arm housing is attached. By limiting the swivel range of the rocker arm, a canting or undesired excessive inertia-induced motion can be prevented, which may otherwise lead to a malfunction of the stopper mechanism.

The recess may comprise a plastic lining or coating on an interior surface that reduces friction and/or contact noises. Particularly if the rocker arm is made from a metallic material, it may repeatedly produce a clicking sound when toggling between the blocking position and release position, which sound may be unwanted. This may be suppressed by including a coating or lining by means of a plastic material. However, such a coating or lining may also be provided for reducing a friction of the rocker am. The rocker arm housing may comprise at least one borehole, in which the rocker arm axle is supported for letting it swivel.

A center of gravity of the rocker arm may be arranged between the rocker arm axle and the second end, such that the rocker arm urges to swivel in a direction, in which the blocking section moves downwards. By selecting the geometrical relationship between center of gravity and the position of the rocker arm axle, the rocker arm is completely gravity-driven. The stopper mechanism is thus a passive mechanism that does not rely on active components. For placing the center of gravity in the desired way, the shape of the rocker arm needs to be chosen appropriately. For example, the part of the rocker arm that extends from the rocker arm axle to the second end comprises a greater dimensional extension or a greater volume than the remaining part of the rocker arm.

The first end of the rocker arm may comprise a bifurcation having a first leg and a second leg, wherein the first leg comprises the toggle section, and wherein the second leg faces away from the cover element and is designed to contact a stop surface when the rocker arm is in or beyond the blocking position. The two legs of the bifurcation thus serve for two different purposes, i.e. the coupling with the cover element and limiting the sections at the first end. By using two separate legs for this, the weight of the rocker arm at the first end is minimized, which enhances the gravity-driven swiveling.

However, the rocker arm does not necessarily require a bifurcation. Instead, a curve, kinked, bent or even straight element may be used.

The blocking section and the second leg may be substantially parallel to each other, wherein the first leg and the second leg enclose an angle in a range of 15° to 60°. With increasing angle, the first leg may reach further into the cover path.

At least the first leg may have a rounded distal edge. Thus, a harmonic contact between the cover element or the peripheral element and the first leg may be accomplished. If the first leg has an end profile that substantially forms a circular arch, a contact region between the cover element or the peripheral element and the first leg may be realized by a single line or a stripe-shaped area, independent of the momentary alignment of the rocker arm.

The rocker arm housing may be attached to the first guiding rail and may be designed to support the first guiding rail by locally bridging the slot. Since the elongated slot, if the first guiding rail is equipped with such, weakens the guiding rail and the rocker arm housing supports to increase the stability of the guiding rail again.

However, the rocker arm housing may be installed adjacent to the first guiding rail, if an elongated slot is not provided.

The peripheral element may have an engagement edge that may be designed to contact the at least one blocking element, wherein the engagement edge may at least partially be beveled relative to the cover path to reduce impact-noise with the at least one blocking element. The engagement edge of the peripheral element is provided to contact the at least one blocking element when moving the cover element to its closed position. When moving into the closed position, the engagement edge hits the at least one blocking element, which produces a clicking noise. The strength of the noise increases with increasing velocity of the cover element. However, it has been found that by beveling the engagement edge relative to the cover path this noise is significantly reducible, resulting in a more convenient working environment at the access station.

The at least one blocking element may be made from a metallic material. It is conceivable to use aluminium, which is sufficiently rigid for the intended purpose. The at least one blocking element may be cast and/or machined. However, it is also conceivable to make it from other materials, such as a plastic material.

The at least one blocking element may comprise two blocking elements arranged at a distance to each other at the edge region of the access opening. The blocking function may thus be accomplished by two separate blocking elements, which are arranged at the same edge region. The side of the respective storage container facing towards the storage section will then be in contact with two blocking elements and will thus be reliably prevented from being moved into the storage section.

The at least one blocking element may be configured to urge the toggle section into the cover path passively. The blocking mechanism is thus configured to urge the at least one blocking element into the conveying path without an active mechanical device, such as an actuator or the such. For example, the at least one blocking element is configured for urging into the conveying path substantially gravity-driven. This means that the at least one blocking element swivels or otherwise moves into the conveying path if the cover element does not retract it from there. In an alternative, the at least one element may be spring-loaded, such that the at least one blocking element is permanently pushed by a spring into the conveying path, unless the cover element retracts it.

The access station may comprise at least one position sensor coupled with the at least one blocking element, wherein the at least one position sensor is configured to detect, if the at least one blocking element is in the release position. The position sensor may thus detect if the conveying path is free. If the conveying path is not free, operation of a conveying device for moving storage containers to and from the access station may be interrupted or prevented. If the conveying path is free, the storage container may be moved. The position sensor may be connected to a control system of an automated storage and retrieval system, which may thus retrieve information about the state of the access station to control operation of a conveying device. Detecting the release position allows to confirm that the cover element is fully covering the access opening.

In a second aspect, there is provided an automated storage and retrieval system, comprising a rail system comprising a first set of parallel rails arranged in a horizontal plane and extending in a first direction (X), and a second set of parallel rails arranged in the horizontal plane and extending in a second direction (Y) which is orthogonal to the first direction (X), which first and second sets of rails form a grid pattern in the horizontal plane comprising a plurality of adjacent grid cells, each comprising a grid opening defined by a pair of neighboring rails of the first set of rails and a pair of neighboring rails of the second set of rails; a plurality of stacks of storage containers arranged in storage columns located beneath the rail system, wherein each storage column is located vertically below a grid opening; a plurality of container handling vehicles for handling storage containers in the automated storage and retrieval system, each vehicle being configured to move on the rail system above the storage columns; an access station according to the above description, and at least one storage system conveyor arranged below at least one port column, wherein the at least one storage system conveyor is arranged to transfer storage containers between a transfer position below the at least one port column, to the receiving space of the access station along the conveying path.

The access station according to the above description is thus integrated into an automated storage and retrieval system mentioned further above. Storage containers can be conveyed between the transfer position and the receiving space, wherein the access station blocks the storage container from being moved when the cover element is open.

In a third aspect, there is provided a method for operating an access station for an automated storage and retrieval system having a storage section for storing storage containers, wherein the access station comprises a frame structure enclosing a receiving space for receiving a storage container to be transferred from or into the storage section along a conveying path, an access opening for accessing the receiving space from externally of the access station, a movable cover element for selectively covering the access opening, and a stopper mechanism with at least one movably supported blocking element, wherein the cover element is designed to move along a cover path between an open position, in which the access opening is at least partially opened, and a closed position, in which the access opening is covered, wherein the method comprises: placing a storage container in the receiving space while the cover element is closed, opening the cover element, thereby toggling the at least one blocking element (e.g., releasing the toggle section of the at least one blocking element such that the blocking section urges into the conveying path) such that the blocking section blocks the conveying path for storage containers, and closing the cover element, thereby toggling the at least one blocking element into a release position to release the conveying path. In some examples, the closed cover element rests on a toggle section of the at least one blocking element, such that a blocking section of the at least one blocking element is urged out of the conveying path to release the conveying path for storage containers.

In a fourth aspect, there is provided a kit for an access station of an automated storage and retrieval system, the kit comprising a stopper mechanism having at least one blocking element, which is movably supportable at an edge region of an access opening of the access station and comprises a blocking section and a toggle section, and at least one peripheral element attachable to a lateral side of a cover element of the access station, such that the at least one peripheral element laterally protrudes from the cover element. The at least one blocking element is preferably realized as a rocker arm explained further above.

### BRIEF DESCRIPTION OF THE DRAWINGS

Following drawings are appended to facilitate the understanding of the disclosure. The drawings show embodiments of the present disclosure, which will now be described by way of example only, where:

FIG. 1 is a perspective view of a framework structure of a prior art automated storage and retrieval system.

FIG. 2 is a perspective view of a prior art container handling vehicle having an internally arranged cavity for carrying storage containers therein.

FIG. 3 is a perspective view of a prior art container handling vehicle having a cantilever for carrying storage containers underneath.

FIG. 4 is a perspective view, seen from below, of a prior art container handling vehicle having an internally arranged cavity for carrying storage containers therein.

FIG. 5 is a perspective front view of an access station with a closed cover element.

FIG. 6 is a perspective front view of the access station with an open cover element.

FIG. 7 is a perspective view of the closed cover element and a stopper mechanism of the access station.

FIG. 8 is a perspective view of the cover element with a peripheral element attached to it.

FIGS. 9 and 10 are lateral views of a receiving space in the access station with stopper mechanism in released state (FIG. 9) and in blocked state (FIG. 10).

FIG. 11 is a lateral view on the stopper mechanism.

FIG. 12 is a perspective view on a first guide rail with the stopper mechanism.

FIGS. 13a, 13b and 14 are detail views of the stopper mechanism.

FIG. 15 is a lateral views of the receiving space in the access station with stopper mechanism in blocked state.

FIG. 16 shows a detail view of a stopper mechanism.

### DETAILED DESCRIPTION

In the following, embodiments will be discussed in more detail with reference to the appended drawings. It should be understood, however, that the drawings are not intended to limit the invention to the subject-matter depicted in the drawings.

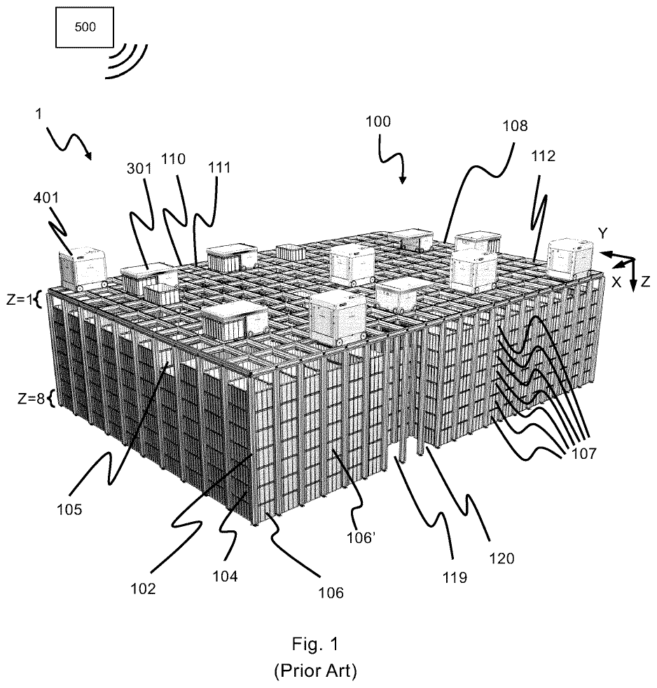

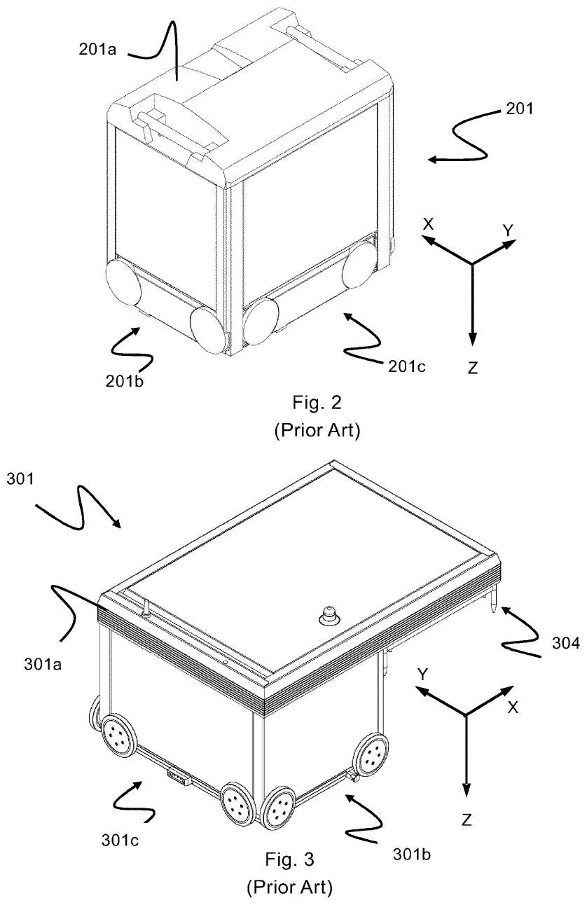

The framework structure 100 of the automated storage and retrieval system 1 is constructed in a similar manner to the prior art framework structure 100 described above in connection with FIGS. 1-3. That is, the framework structure 100 comprises a number of upright members 102, and comprises a first, upper rail system 108 extending in the X direction and Y direction.

The framework structure 100 further comprises storage compartments in the form of storage columns 105 provided between the members 102 wherein storage containers 106 are stackable in stacks 107 within the storage columns 105.

The framework structure 100 can be of any size. In particular it is understood that the framework structure can be considerably wider and/or longer and/or deeper than disclosed in FIG. 1. For example, the framework structure 100 may have a horizontal extent of more than 700×700 columns and a storage depth of more than twelve containers.

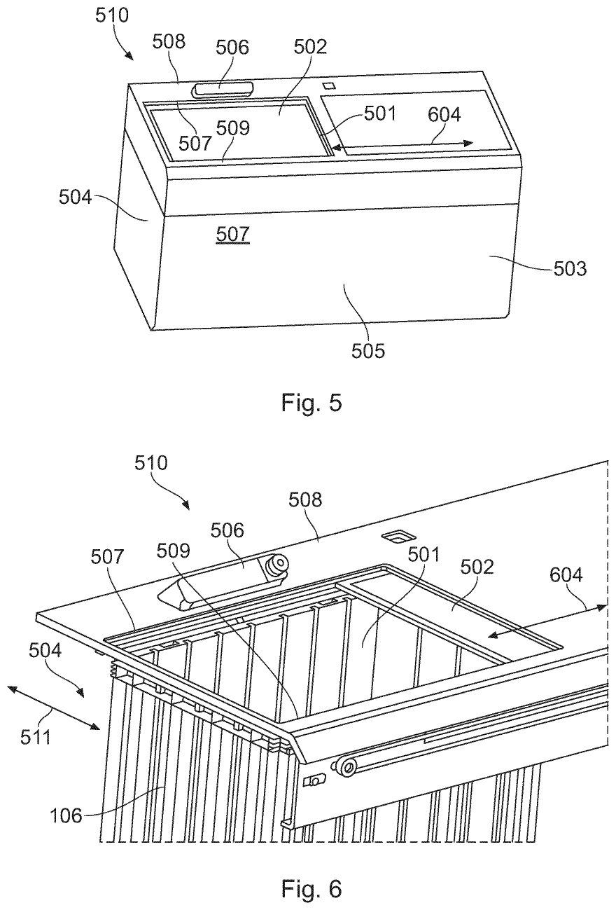

One embodiment of the automated storage and retrieval system according to the present disclosure will now be discussed in more detail with reference to FIGS. 5 to 14.

FIG. 5 shows an access station 510 for an automated storage and retrieval system. The access station 510 comprises a frame structure 503, which exemplarily has housing panels, stiffening components, and other elements, which are attached to each other to form a part of the exterior shape of the access station 510. The frame structure 503 in this example provides a substantially closed surface to the user. Inside the frame structure 503, a receiving space 504 is arranged and enclosed by the frame structure 503. A user of the access station 510 may stand or sit in front of a front side 505 and may interact with a control device 506 arranged on an upper side 508 of the access station 510. The control device 506 may allow a user to send a command into the control system 500 to remove a storage container from the access station 510 and to provide another storage container into the access station 510.

On the upper side 508, the access station 510 comprises an access opening 501, which allows the user to access a storage container arranged in the receiving space 504 by reaching through the access opening 501. The access opening 501 has a front edge 509, which extends along the front side 505 of the access station 510. A rear edge 507 is opposed to the front edge 509 and faces away from the user of the access station 510. In FIG. 5, the access opening 501 is temporarily closed by a cover element 502 that is slidable between an open position and a closed position along a cover path 604. Thus, in the state shown in FIG. 5, a user cannot access the receiving space 504. FIG. 6 shows the access station 510 in another view. Here, some components of the frame structure 503 are left away for enhancing the view onto the receiving space 504. Here, a storage container 106 is arranged in the receiving space 504 and the cover element 502 is in an open position. Thus, the interior of the storage container 106 is accessible for a user through the access opening 501. The size of the access opening 501 substantially corresponds to the size of the storage container 106. It may be useful to let the access opening 501 be slightly smaller than the storage container 106 to avoid a user removing the storage container 106 from the receiving space 504 by pulling it through the access opening 501.

A storage system conveyor, which is not depicted herein, is capable of moving the storage container 106 to the receiving space 504 or away from it, along a conveying path 511. The access station 510 is preferably configured to restrict the movability of the storage container 106 only to the conveying path 511.

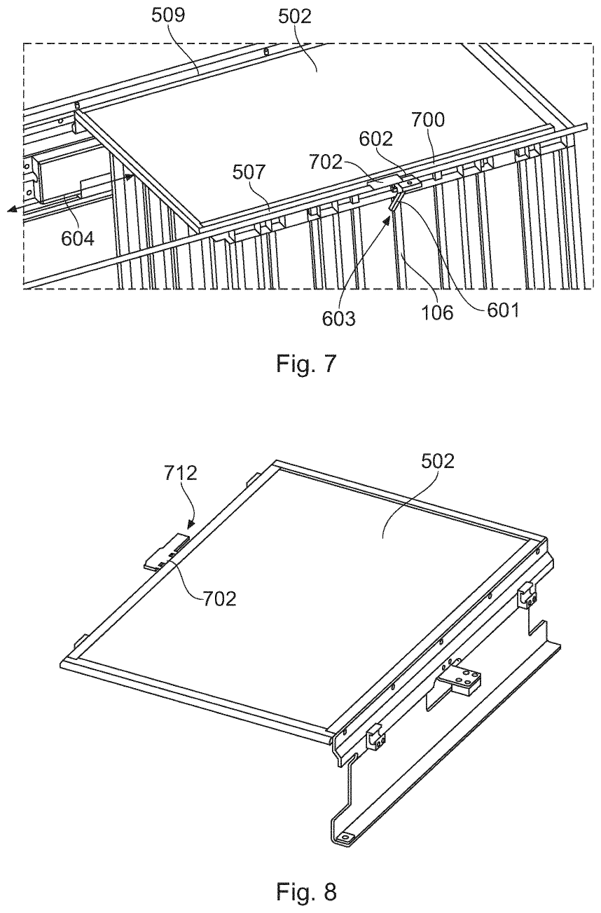

FIG. 7 shows a stopper mechanism 700, which is arranged on an interior side of the frame structure 503 and in the region of the rear edge 507. In this example, the stopper mechanism 700 comprises a swivably supported blocking element 601 in form of a rocker arm, which is shown with reference numeral 701 in the further figures. The stopper mechanism 700 is configured for selectively blocking the storage container 106 from moving away from the receiving space 504 by partially extending into the conveying path 511.

A toggle section 602 of the blocking element 601 partially extends into the cover path 604. A blocking section 603 of the blocking element 601, which is arranged at an opposite end of the blocking element 601, reaches into the conveying path 511 of the storage container 106. The cover element 502 is configured to slide over the toggle section 602 of the blocking element 601, such that it is urged out of the cover path 604 by conducting a swiveling motion. In doing so, the blocking section 603 is retracted from the conveying path 511 and thus releases the storage container 106 to move along the conveying path 511 again. Thus, the blocking element 601 can be toggled between a release position for releasing the storage container 106 to move along the conveying path 511 and a blocking position for blocking the position of the storage container 106 only through the action of the cover element 502. The blocking element 601 is configured to urge into the conveying path 511 and into the cover path passively. This is exemplarily accomplished through the action of gravity.

As indicated in FIG. 7 and shown in further detail in FIG. 8, the cover element 502 comprises a plate-shaped, flat, and substantially rigid peripheral element 702, which is attached on a lateral side of the cover element 502. The peripheral element 702 is configured to slide over the toggle section 602 of the blocking element 601. It comprises an engagement edge 712 that is designed to contact the blocking element 601. Exemplarily, it is at least partially beveled relative to the cover path, such that an impact-noise, which is produced when contacting the blocking element 601, can be reduced.

The position of the peripheral element 702 along the cover element 502 can be chosen to improve the position of the blocking element 601 in the conveying path 511. Instead of a single peripheral element 702, also two or more peripheral elements 702 may be distributed along the cover element 502 for improving the locations of the blocking elements 601.

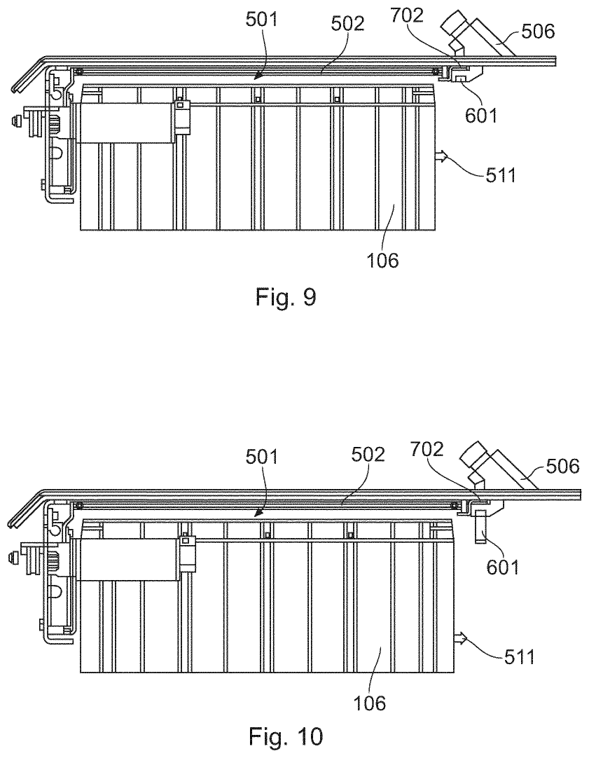

FIGS. 9 and 10 show the access station 510 in a lateral view. In FIG. 9, the peripheral element 702 is arranged on the toggle section 602, such that the blocking element 601 is toggled into the release position, and such that the storage container 106 can move along the conveying path 511. In FIG. 10, the cover element 502 is open and thus, the peripheral element 702 is not in contact with the blocking element 601, such that it urges into the conveying path 511. The storage container 106 is thus blocked by the blocking element 601.

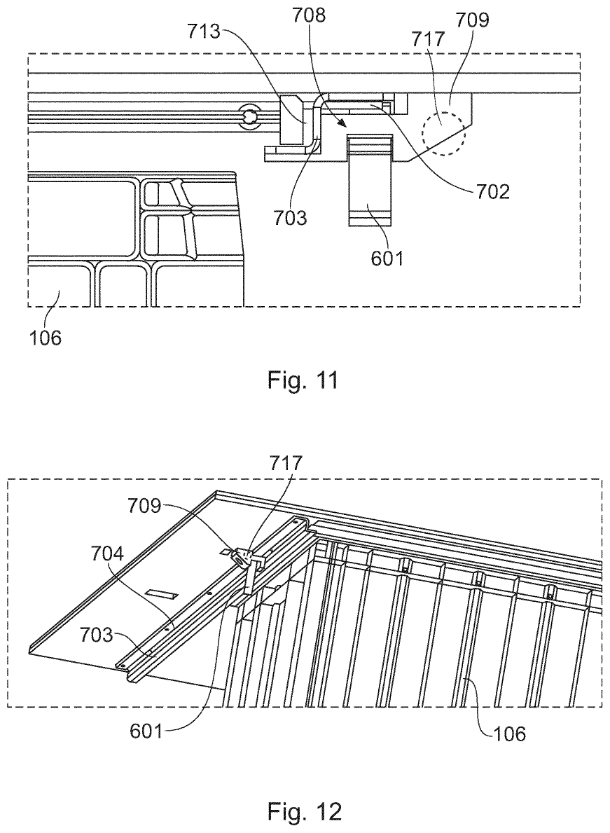

FIG. 11 shows a first guiding rail 703, in which the cover element 502 is slidably supported. It is understood that there is a corresponding second guiding rail 703 at the opposite edge of the access opening 501 for guiding the opposite lateral edge of the cover element 502. Here, the first guiding rail 703 has an elongated recess 713 that corresponds to a lateral side of the cover element 502, in which the cover element 502 can slide. The first guiding rail 703 is attached to the frame structure 503 underneath the access opening 501. The peripheral element 702 is attached to the respective lateral side of the cover element 502 and extends from the cover element 502 through an elongated slot to a lateral side of the first guiding rail opposite the cover element 502.

The blocking element 601 is arranged in a recess 708 of a rocker arm housing 709, which is attached to the first guiding rail 703. If the cover element 502 slides along the first guiding rail 703, the peripheral element 702 is able to slide over the blocking element 601 when the cover element 502 travels along the cover path 604. The first guiding rail 703 comprises an S-shaped profile cross-section and the rocker arm housing 709 has a corresponding S-shaped profile cross-section, such that the rocker arm housing 709 can be attached directly to an underside of the first guiding rail 703 in order to support it. Thus, the rocker arm housing 709 locally bridges the elongated slot. This is clearly apparent from FIG. 12, in which the elongated slot 704 is shown from underneath the access opening 501 and is locally bridged by the rocker arm housing 709.

In FIGS. 11 and 12 a conceivable installation position of a position sensor 717 is indicated by dashed lines. The position sensor 717 may be coupled with the blocking element 601 in order to detect, whether it is swiveled upwards or downwards, i.e. whether the conveying path 511 is free or blocked. The position sensor 717 may be connected to a control system of the automated storage and retrieval system, to which the access station 510 belongs, to consider the state of the access station 510 and/or of the conveying path 511.

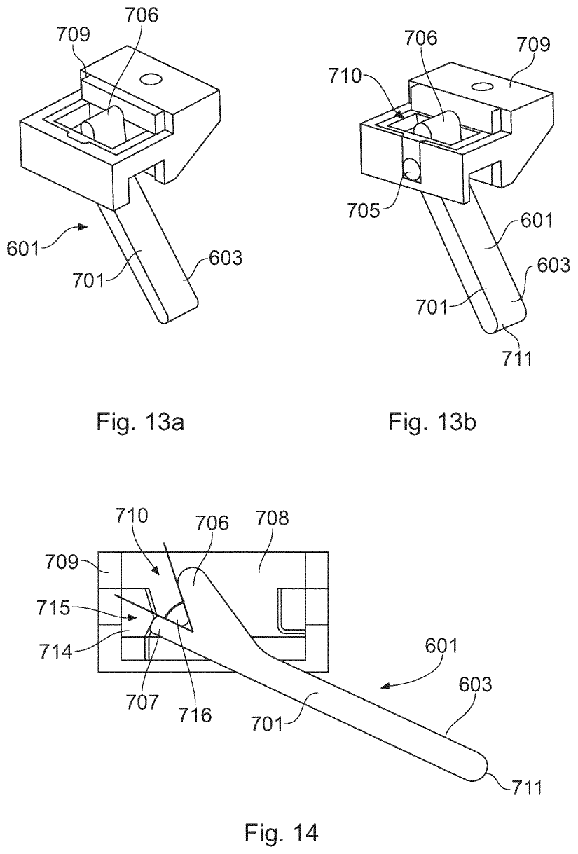

In FIGS. 13a, 13b and 14, the blocking element 601 is shown in the form of a rocker arm 701. The rocker arm 701 is swivably supported through a rocker arm axle 705 in the rocker arm housing 709. The toggle section 602 comprises a bifurcated first end having a first leg 706 and a second leg 707. The first leg 706 protrudes out of the rocker arm housing 709 in order to be contacted by the cover element 502 or the peripheral element 702. The blocking section 603 is extending away from the rocker arm housing 709 to reach into the conveying path 511. The rocker arm axle 705 is arranged between the blocking section 603 and the toggle section 602. The distance from the blocking section 603 to the rocker arm axle 705 is clearly higher than the distance from the toggle section 602 to the rocker arm axle 705. Thus, the blocking section 603 generates a greater torque onto the rocker arm axle 705 than the toggle section 602, thus urging the blocking section 603 downwardly into the conveying path 511 gravity-driven. By this, the toggle section, i.e. the first leg 706, is pushed into the cover path.

As illustrated in FIG. 14, the second leg 707 is designed to reach a projection 715 of the lining 714 of the rocker arm housing 709, which projection 715 creates a stop surface, when the blocking section 603 reaches a position, in which it is clearly swiveled out of the conveying path 511. For example, the second leg 707 reaches the projection 715 when the blocking section 603 assumes an angle of about 60° to a vertical line. This prevents the rocker arm 701 to swivel further and thus, the lining 714 acts to limit the swiveling motion.

The lining 714 is preferably made from a plastic material that dampens the noise of the rocker arm 701 when toggling between both positions. The rocker arm 701 is preferably made from a metallic material, e.g. aluminium.

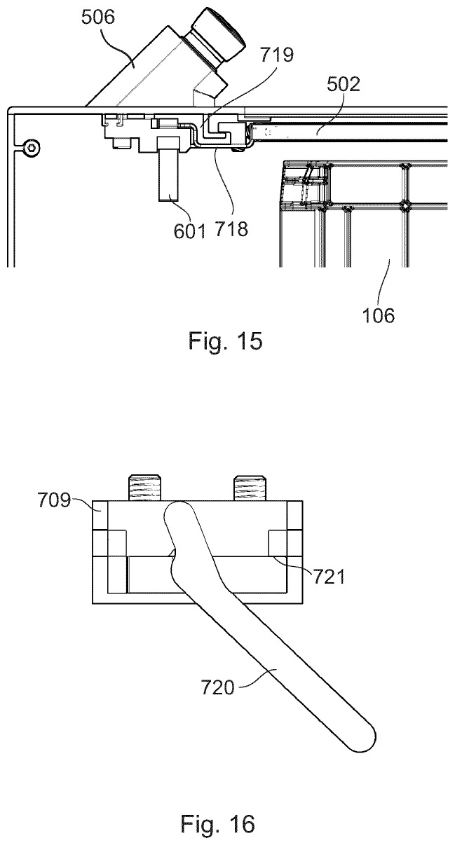

FIG. 15 shows the access station 510 in a lateral view. Here, a peripheral element 718 is shown, which has several kinks 719, such that the peripheral element 718 reaches around the first guiding rail 703 and does not require a slot 704.

FIG. 16 shows a modified rocker arm 720, which substantially corresponds to the rocker arm 710 of FIG. 14, but does not comprise the second leg 707. The rocker arm 720 thus is merely hanging down if it is not activated. The rocker arm housing 709 has a stopping surface that comes into contact with the rocker 710 if it swivels upwardly.

In the preceding description, various aspects of the delivery vehicle and the automated storage and retrieval system according to the present disclosure have been described with reference to the illustrative embodiment. For purposes of explanation, specific numbers, systems, and configurations were set forth in order to provide a thorough understanding of the system and its workings. However, this description is not intended to be construed in a limiting sense. Various modifications and variations of the illustrative embodiment, as well as other embodiments of the system, which are apparent to persons skilled in the art to which the disclosed subject matter pertains, are deemed to lie within the scope of the appended claims.

Also disclosed herein are the following numbered clauses:

Clause 1. An access station (510) for an automated storage and retrieval system (1) having a storage section for storing storage containers (106), the access station (510) comprising:
a frame structure (503) enclosing a receiving space (504) for receiving a storage container (106) to be transferred from or into the storage section along a conveying path (511),
an access opening (501) for accessing the receiving space (504) from externally of the access station,
a movable cover element (502) for selectively covering the access opening (501), and
a stopper mechanism (700),
wherein the cover element (502) is configured to move along a cover path (604) between an open position, in which the access opening (501) is at least partially opened in order to allow access, and a closed position, in which the access opening (501) is covered,
wherein the stopper mechanism (700) comprises at least one blocking element (601), which is toggleable between a blocking position and a release position,
wherein the at least one blocking element (601) is arranged at an edge region of the access opening (501) and comprises a blocking section (603) and a toggle section (602),
wherein the at least one blocking element (601) is configured to urge the toggle section (602) into the cover path (604) and the blocking section (603) into the conveying path (511) to block the conveying path (511) for storage containers (106), and
wherein the cover element (502) is configured to slide over the toggle section (602) of the at least one blocking element (601), such that it is urged out of the cover path (604) to retract the blocking section (603) from the conveying path (511), when the cover element (502) is moved into the closed position.

Clause 2. The access station (510) in accordance with clause 1,
wherein the at least one blocking element (601) comprises a rocker arm (701) with a first end (710) and a second end (711),
wherein the toggle section (602) is arranged at the first end (710),
wherein the blocking section (603) is arranged at the second end (711), and
wherein a rocker arm axle (705) is arranged between the toggle section (602) and the blocking section (603) to swivably support the rocker arm (701).

Clause 3. The access station (510) in accordance with clause 2,
wherein the rocker arm axle (705) is arranged in a distance to the cover path (604) and is aligned substantially parallel to the access opening (501) and substantially perpendicular to a movement direction of the cover element (502) along the cover path (604).

Clause 4. The access station (510) in accordance with any one of the preceding clauses,
wherein the stopper mechanism (700) comprises a peripheral element (702) attached to a lateral side of the cover element (502) and laterally protruding from the cover element (502), and
wherein the peripheral element (702) is designed to contact and slide over the at least one blocking element (601).

Clause 5. The access station (510) in accordance with any one of the preceding clauses,
wherein the cover element (502) is slidably supported in a pair of parallel guiding rails (703) arranged along two opposite edges of the access opening (501), and
wherein the stopper mechanism (700) is arranged adjacent to or connected with one of the guiding rails (703).

Clause 6. The access station (510) in accordance with clause 5,
wherein the at least one blocking element (601) is arranged at a lateral side of a first one of the guiding rails (703), which faces away from a respective second one of the guiding rails (703).

Clause 7. The access station (510) in accordance with clause 4 and 6,
wherein the first guiding rail (703) comprises an elongated slot (704), through which the peripheral element (702) extends.

Clause 8. The access station (510) in accordance with clause 4 or 7,
wherein the peripheral element (702) is a flat component that substantially extends parallel to the cover element (502).

Clause 9. The access station (510) in accordance with clause 2 or 3,
wherein the rocker arm (701) is arranged in a recess (708) of a rocker arm housing (709), which is designed to limit a swivel range of the rocker arm (701).

Clause 10. The access station (510) in accordance with clause 9,
wherein the recess (708) comprises a plastic lining (714) or coating on an interior surface that reduces friction and/or contact noises.

Clause 11. The access station (510) in accordance with clause 2, 3, 9 or 10,
wherein a center of gravity of the rocker arm (701) is arranged between the rocker arm axle (705) and the second end (711), such that the rocker arm (701) urges to swivel in a direction, in which the blocking section (603) moves downwards.

Clause 12. The access station (510) in accordance with any one of clauses 2, 3, 9, 10 or 11,
wherein the first end (710) comprises a bifurcation having a first leg (706) and a second leg (707),
wherein the first leg (706) comprises the toggle section (602), and
wherein the second leg (707) faces away from the cover element (502) and is designed to contact a stop surface (715) when the rocker arm (701) is in or beyond the blocking position.

Clause 13. The access station (510) in accordance with clause 12,
wherein the blocking section (603) and the second leg (707) are substantially parallel to each other, and
wherein the first leg (706) and the second leg (707) enclose an angle (716) in a range of 15° to 60°.

Clause 14. The access station (510) in accordance with clause 12 or 13,
wherein at least the first leg (706) has a rounded distal edge.

Clause 15. The access station (510) in accordance with clause 9,
wherein the rocker arm housing (709) is installed adjacent to the first guiding rail (703).

Clause 16. The access station (510) in accordance with clause 4 or 7,
wherein the peripheral element (702) has an engagement edge (712) that is designed to contact the at least one blocking element (601), and
wherein the engagement edge (712) is at least partially beveled relative to the cover path (604) to reduce impact-noise with the at least one blocking element (601).

Clause 17. The access station (510) in accordance with any one of the preceding clauses,
wherein the at least one blocking element (601) comprises two blocking elements (601) arranged at a distance to each other at the edge region of the access opening (501).

Clause 18. The access station (510) in accordance with any one of the preceding clauses,
wherein the at least one blocking element (601) is configured to urge the toggle section (602) into the cover path (604) passively.

Clause 19. The access station (510) in accordance with any one of the preceding clauses,
comprising at least one position sensor (717) coupled with the at least one blocking element (601),
wherein the at least one position sensor (717) is configured to detect, if the at least one blocking element (601) is in the release position.

Clause 20. An automated storage and retrieval system, comprising:
a rail system (108) comprising a first set of parallel rails (110) arranged in a horizontal plane and extending in a first direction (X), and a second set of parallel rails (111) arranged in the horizontal plane and extending in a second direction (Y) which is orthogonal to the first direction (X), which first and second sets of rails (110, 111) form a grid pattern in the horizontal plane comprising a plurality of adjacent grid cells, each comprising a grid opening defined by a pair of neighboring rails (110) of the first set of rails (110) and a pair of neighboring rails (111) of the second set of rails (111);
a plurality of stacks (107) of storage containers (106) arranged in storage columns (105) located beneath the rail system (108), wherein each storage column (105) is located vertically below a grid opening;

a plurality of container handling vehicles (201, 301, 401) for handling storage containers (106) in the automated storage and retrieval system, each vehicle (201, 301, 401) being configured to move on the rail system (108) above the storage columns (105);
an access station (510) in accordance with any of the preceding clauses, and
at least one storage system conveyor arranged below at least one port column (119, 120), wherein the at least one storage system conveyor is arranged to transfer storage containers (106) between a transfer position below the at least one port column (119, 120), to the receiving space (504) of the access station (510) along the conveying path (511).

Clause 21. A method for operating an access station (510) for an automated storage and retrieval system (1) having a storage section for storing storage containers (106),
wherein the access station (510) comprises a frame structure (503) enclosing a receiving space (504) for receiving a storage container (106) to be transferred from or into the storage section along a conveying path (511), an access opening (501) for accessing the receiving space (504) from externally of the access station (510), a movable cover element (502) for selectively covering the access opening (501), and a stopper mechanism (700) with at least one movably supported blocking element, wherein the cover element (502) is designed to move along a cover path (604) between an open position, in which the access opening (501) is at least partially opened, and a closed position, in which the access opening (501) is covered,
wherein the method comprises:
   placing a storage container (106) in the receiving space (504) while the cover element (502) is closed, wherein the closed cover element (502) rests on a toggle section (602) of the at least one blocking element (601), such that a blocking section (603) of the at least one blocking element (601) is urged out of the conveying path (511) to release the conveying path (511) for storage containers (106),
   opening the cover element (502), thereby releasing the toggle section (602) of the at least one blocking element, such that the blocking section (603) urges into the conveying path (511) to block the conveying path (511)
for storage containers (106), and
   closing the cover element (502), thereby sliding over the toggle section (602) of the at least one blocking element to release the conveying path (511) again.

Clause 22. Kit for an access station of an automated storage and retrieval system, the kit comprising a stopper mechanism (700) having at least one blocking element (601), which is movably supportable at an edge region of an access opening (501) of the access station and comprises a blocking section (603) and a toggle section, and at least one peripheral element attachable to a lateral side of a cover element (502) of the access station, such that the at least one peripheral element (702) laterally protrudes from the cover element (502).

### LIST OF REFERENCE NUMBERS

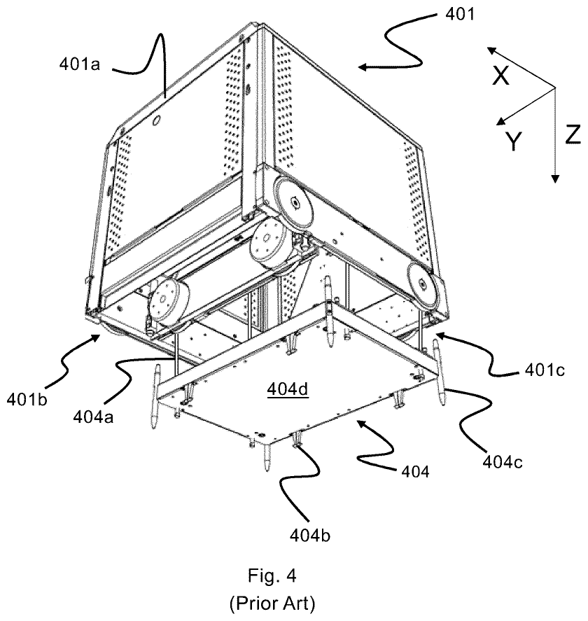

Prior art (FIGS. 1-4):
1 Prior art automated storage and retrieval system
100 Framework structure
102 Upright members of framework structure
104 Storage grid
105 Storage column
106 Storage container
106′ Particular position of storage container
107 Stack
108 Rail system
110 Parallel rails in first direction (X)
111 Parallel rails in second direction (Y)
112 Access opening
119 First port column
120 Second port column
201 Prior art container handling vehicle
201a Vehicle body of the container handling vehicle 201
201b Drive means/wheel arrangement/first set of wheels in first direction (X)
201c Drive means/wheel arrangement/second set of wheels in second direction (Y)
301 Prior art cantilever container handling vehicle
301a Vehicle body of the container handling vehicle 301
301b Drive means/first set of wheels in first direction (X)
301c Drive means/second set of wheels in second direction (Y)
304 Gripping device
401 Prior art container handling vehicle
401a Vehicle body of the container handling vehicle 401
401b Drive means/first set of wheels in first direction (X)
401c Drive means/second set of wheels in second direction (Y)
404 Gripping device
404a Lifting band
404b Gripper
404c Guide pin
404d Lifting frame
500 Control system
501 Access opening
502 Cover element
503 Frame structure
504 Receiving space
505 Front side
506 Control device
507 Rear edge
508 Upper side
509 Front edge
510 Access station
511 Conveying path
60 Blocking element
602 Toggle section
603 Blocking section
604 Cover path
700 Stopper mechanism
701 Rocker arm
702 Peripheral element
703 Guiding rail
704 Slot
705 Rocker arm axle
706 First leg
707 Second leg
708 Recess
709 Rocker arm housing
710 First end
711 Second end
712 Engagement edge
713 Elongated recess
714 Lining
715 Projection
716 Angle
717 Position sensor
X First direction
Y Second direction
Z Third direction

1. An access station for an automated storage and retrieval system having a storage section for storing storage containers-(106), the access station comprising:
a frame structure enclosing a receiving space for receiving a storage container to be transferred from or into the storage section along a conveying path
an access opening for accessing the receiving space,
a movable cover element for selectively covering the access opening, and
a stopper mechanism,
wherein the cover element is configured to move along a cover path between an open position and a closed position,
wherein the stopper mechanism comprises at least one blocking element which is toggleable between a blocking position and a release position,
wherein the blocking element is in the blocking position when the cover element is in the open position, and in a release position when the cover element is in the closed position, and
wherein when in the blocking position, the blocking element blocks the conveying path for storage containers.

2. The access station of claim 1, wherein the at least one blocking element comprises a blocking section and a toggle section

3. The access station of claim 2, wherein the cover element is configured to slide over the toggle section of the at least one blocking element to toggle the blocking element between the blocking position and the release position.

4. The access station of claim 2, wherein the at least one blocking element is configured to urge the toggle section into the cover path and to urge the blocking section into the conveying path to block the conveying path for storage containers.

5. The access station of claim 2, wherein the cover element is configured to slide over the toggle section of the at least one blocking element such that the toggle section is urged out of the cover path to retract the blocking section from the conveying path when the cover element is moved into the closed position.

6. (canceled)

7. (canceled)

8. The access station of claim 2,
wherein the at least one blocking element comprises a rocker arm with a first end and a second end,
wherein the toggle section is arranged at the first end
wherein the blocking section is arranged at the second end, and
wherein a rocker arm axle is arranged between the toggle section and the blocking section to swivably support the rocker arm.

9. The access station of claim 8,
wherein the rocker arm axle is arranged at a distance to the cover path and is aligned substantially parallel to the access opening and substantially perpendicular to a movement direction of the cover element along the cover path.

10. The access station of claim 1,
wherein the stopper mechanism comprises a peripheral element attached to a lateral side of the cover element and laterally protruding from the cover element, and
wherein the peripheral element is designed to contact and slide over the at least one blocking element.

11. The access station of claim 1,
wherein the cover element is slidably supported in a pair of parallel guiding rails arranged along two opposite edges of the access opening, and
wherein the stopper mechanism is arranged adjacent to or connected with one of the guiding rails.

12. The access station of claim 11,
wherein the at least one blocking element is arranged at a lateral side of a first one of the guiding rails, which faces away from a respective second one of the guiding rails

13. (canceled)

14. The access station of claim 10,
wherein the peripheral element is a flat component that substantially extends parallel to the cover element.

15. The access station of claim 8,
wherein the rocker arm is arranged in a recess of a rocker arm housing which is designed to limit a swivel range of the rocker arm.

16. (canceled)

17. The access station of claim 8,
wherein a center of gravity of the rocker arm is arranged between the rocker arm axle and the second end, such that the rocker arm urges to swivel in a direction, in which the blocking section moves downwards.

18. The access station of claim 8,
wherein the first end comprises a bifurcation having a first leg and a second leg
wherein the first leg comprises the toggle section and
wherein the second leg faces away from the cover element and is designed to contact a stop surface when the rocker arm is in or beyond the blocking position.

19. (canceled)

20. (canceled)

21. (canceled)

22. The access station of claim 10,
wherein the peripheral element has an engagement edge that is designed to contact the at least one blocking element and
wherein the engagement edge is at least partially beveled relative to the cover path to reduce impact-noise with the at least one blocking element.

23. (canceled)

24. The access station of claim 2,
wherein the at least one blocking element is configured to urge the toggle section into the cover path passively.

25. (canceled)

26. An automated storage and retrieval system, comprising:
a rail system comprising a first set of parallel rails arranged in a horizontal plane and extending in a first direction, and a second set of parallel rails arranged in the horizontal plane and extending in a second direction which is orthogonal to the first direction, which first and second sets of rails form a grid pattern in the horizontal plane comprising a plurality of adjacent grid cells, each comprising a grid opening defined by a pair of neighboring rails of the first set of rails and a pair of neighboring rails of the second set of rails;
a plurality of stacks of storage containers arranged in storage columns located beneath the rail system wherein each storage column is located vertically below a grid opening;
a plurality of container handling vehicles for handling storage containers in the automated storage and retrieval system, each vehicle being configured to move on the rail system above the storage columns
an access station according to claim 1, and
at least one storage system conveyor arranged below at least one port column, wherein the at least one storage system conveyor is arranged to transfer storage containers between a transfer position below the at least one port column to the receiving space of the access station along the conveying path.

27. A method for operating an access station for an automated storage and retrieval system having a storage section for storing storage containers,
wherein the access station comprises a frame structure enclosing a receiving space for receiving a storage container to be transferred from or into the storage section along a conveying path an access opening for accessing the receiving space from externally of the access station a movable cover element for selectively covering the access opening, and a stopper mechanism with at least one movably supported blocking element, wherein the cover element is designed to move along a cover path between an open position, in which the access opening is at least partially opened, and a closed position, in which the access opening is covered,
wherein the method comprises:
placing a storage container in the receiving space while the cover element is closed,
opening the cover element thereby toggling the at least one blocking element into a blocking position to block the conveying path for storage containers, and
closing the cover element, thereby toggling the at least one blocking element into a release position to release the conveying path.

28. The method of claim 27, wherein the closed cover element rests on a toggle section of the at least one blocking element, such that a blocking section of the at least one blocking element is urged out of the conveying path to release the conveying path for storage containers.

29. The method of claim 28, wherein opening the cover element releases the toggle section of the at least one blocking element, such that the blocking section urges into the conveying path.

30. (canceled)
